(19) United States
(12) Patent Application Publication
(10) Pub. No.: US 2005/0049535 A1
(43) Pub. Date: Mar. 3, 2005

(54) Device and method for cosmetically treating cellulite

(76) Inventor: Johannes Reinmuller, Wiesbaden (DE)

Correspondence Address: FULBRIGHT & JAWORSKI;MARKET SQUARE, 801 PENNSLYVANIA, N.W., WASHINGTON, DC, 200042604, US

(21) Appl. No.: 10/964,768

(22) Filed: Oct. 15, 2004

Related U.S. Application Data
(62) Division of application No. 09/600,347, filed on Jul. 14, 2000.

(30) Foreign Application Priority Data
Jan. 16, 1998 (DE) 198 01 471.6

(51) Int. Cl. A61H 9/00

(52) U.S. Cl. 601/160

(57) ABSTRACT

The invention relates to a device for transdermally exerting a defined pressure on subcutaneous tissue, especially where cellulite is present, said device being intended to produce a jet pressure in the range of 1 to 20 bar, so that no mechanical contact is necessary between the device and the skin, and said device having at least one nozzle for a fluid medium. The invention also relates to a cosmetic method for smoothing out cellulite by exerting regional, especially sub-regional, transdermal pressure on an area of skin to be treated with 1 to 50 kg per cm² of skin and, if appropriate, by repeating this process at least once.

The invention relates to a device for transdermally exerting a defined pressure on subcutaneous tissue, especially where cellulite is present, and to a cosmetic method for smoothing out cellulite.

The development of the subcutaneous fatty tissue in humans is dependent on genetic and hormonal factors and also on diet. In some individuals, an excessive amount of subcutaneous fatty tissue develops in certain areas of the body, e.g. on the thighs or in the area of the hips, particularly as a result of the action of the female sex hormone, estrogen. The individual fatty tissue cells become hypertrophic in this case. Because of the anatomical arrangement of these fatty tissue cells within vesicle-like connective tissue septa directly under the skin, the increase in volume of the fatty tissue cells results in stretching of these connective tissue septa, so that a balloon-like deformation occurs. Visible bulges appear in the skin in this way alongside depressions or pits, similar to a mattress suture. This phenomenon is generally referred to as cellulite. It represents a particularly pronounced dystrophy of the subcutaneous tissue and it especially affects females. Cellulite is not therefore a disease, but a normal variation.

Those affected by cellulite generally find it cosmetically unappealing. In view of this, various possibilities for cosmetic treatment have been developed:.
1. Massage and lymph drainage,
2. Treatment with creams and ointments containing ingredients acting in more or less different ways,
3. Treatment using electric fields,
4. Invasive destruction and aspiration of the subcutaneous fatty tissue, known as liposuction.

Massage and lymph drainage primarily affects the water content of the skin and of the subcutaneous fatty tissue. In addition to the manual forms of treatment for this method, a number of treatment devices are available which can be used by the lay person. Favorable effects can be achieved temporarily by these means, but they do not last long.

Cosmetic creams or ointments generally affect only the dead uppermost layer of skin, the horny layer. They cause swelling here and can therefore contribute to improving the surface of the skin. Treatment successes are possible if the formulations contain ingredients which act in different ways and can penetrate fully into the skin and reach as far as the subcutaneous fatty tissue, so that the fatty tissue cells are negatively affected according to the principle of action of hormones in the metabolism and reduce their volume. The success of treatment therefore only lasts for as long as the substance is used. Treatments of this kind are problematic because of the complex relationships within the organism, since the active substance can also affect other organs by passing through the blood or lymph circulation.

Attempted treatments using electric fields are based on the concept that electrolyte shifts negatively affect the metabolism of a fat cell in the subcutaneous fatty tissue and thus can lead to shrinkage of the cell. This is not scientifically proven. The method also entails that the skin must be perforated at least with one electrode because of its electrical resistance. This therefore is an invasive method. In addition, the long-term effect of the treatment is highly dubious since the electrolyte shift in the fat cell is targeted at metabolic processes.

Liposuction using fine cannulas placed directly under the dermis is an effective means of mechanically destroying fatty tissue cells in the subcutaneous fatty tissue and bringing their content to the body surface by means of suction. In addition to an incision wound in the skin, a large wound surface forms directly under the dermis. The subsequent healing, with contraction of the scar tissue, has been found to provide the permanently smooth skin surface which is the aim of the treatment. However, a disadvantage is the surgically invasive nature of the method, which is associated with very high outlay in terms of equipment, personnel and hygiene. These methods are consequently associated with high costs.

Attempts have also been made to influence the subcutaneous fatty tissue with ultrasound, which attempts, because of the low depth of penetration of the ultrasound, have to be done surgically and, because of the heat development, require water cooling in the form of permanent irrigation with water. Still, heat damage to the tissue cannot be completely avoided. In this method, the attack must thus be made directly on the fatty tissue and cannot be done transdermally.

Another disadvantage of the invasive methods used at present lies in the considerable pain experienced by the persons being treated.

Ultrasound, especially with impulse frequencies of greater than 20 kHz, is particularly unsuitable for cosmetic treatment of cellulite because of the increasing heat development and the inadequate depth of penetration through the skin.

An aim of the invention is therefore to permit a cosmetic treatment which is similarly effective to liposuction but which is not invasive and is also carried out very much more simply in terms of personnel, equipment and hygiene.

It is known that, after contusion injuries to the soft parts, defects may remain in the fatty tissue. This proves that deleterious damage of the subcutaneous fatty tissue leads on the one hand to loss of volume and on the other hand to scarring. In such injuries, however, there is also generally tearing of the septa of the subcutaneous connective tissue, damage to the cutaneous system and extensive blood effusions in the deeper layers. After the wound has healed, the results include disfiguring scar impressions in the body surface. In cases of extensive damage of the subcutaneous fatty tissue, with large areas of fatty tissue necrosis, the large number of destroyed fatty tissue cells can no longer be resorbed. This results in the formation of so-called oil cysts, i.e. cystiform cavities which are filled with the oily cell content of the fatty tissue cells, without cellular structures being contained therein. Such cysts are then generally visible or palpable as swellings in the subcutaneous fatty tissue.

A further aim of the invention is therefore to describe conditions which lead directly to a limited change in the fatty tissue structures under the dermis, without causing damage to the skin, the connective tissue septa and the blood and lymph vessels in the subcutaneous fatty tissue.

Moreover, the invention. is intended to ensure that the change in the subcutaneous fatty cells occurs randomly and to a limited extent across the surface, so that the formation of so-called oil cysts is avoided.

It is therefore an object of the present invention to make available a device which permits permanent elimination of hypertrophic cells of the subcutaneous fatty tissue noninvasively and without injuring the skin, or with which the extent of cellulite at least can be permanently reduced.

This object is achieved by means of a device for transdermally exerting a defined pressure on subcutaneous tissue, especially where cellulite is present, said device being intended to produce a jet pressure in the range of 1 to 20 bar, so that no mechanical contact is necessary between the device and the skin, and said device having at least one nozzle for a fluid medium.

With the device according to the invention, it is surprisingly possible to produce a transdermal pressure which is sufficient to randomly damage two-dimensional areas of subcutaneous tissue without causing undesired damage to the skin, the connective tissue septa and the blood and lymph vessels in the subcutaneous fatty tissue. In addition, operation of the device according to the invention does not necessitate any mechanical contact between the device and the skin, so that additional auxiliary means such as lubricants are not required. The handling of the device is further simplified in this way.

The device also permits a limited change of the subcutaneous tissue. In this way, the formation of oil cysts can be avoided, so that use of the device according to the invention does not lead to cosmetically disfiguring swellings or thickenings of the skin.

In a preferred embodiment, the jet width and/or the jet pressure of the device can be regulated. In this way, it is possible, as desired, to adapt the transdermal pressure and thus the extent of the change in the subcutaneous tissue to the respective individual requirements. The mode of action of the device according to the invention can thus be further optimized.

The device according to the invention is intended for any suitable fluid medium, preferably comprising air or water. In a particularly preferred embodiment, the device of the invention can also be intended for elastic and/or nonelastic particles of various materials, such as plastic. These particles can be of any shape, although they will preferably have circular shapes.

In a preferred embodiment, the device is intended for producing a pulsating jet pressure.

In a further preferred embodiment, the device according to the invention has means for controlling the temperature of the fluid medium. These means are known to the skilled person and reference is here made to these means.

A means for controlling the temperature can be intended for combination with the device according to the invention or can be used with it. For example, it is added to the device according to the invention. However, it can also be integrated in the device.

In a preferred embodiment, the means for controlling the temperature consists of a heat coil or of a unit based on a through-flow heater. In a preferred embodiment, this is arranged before the at least one nozzle, and in a particularly preferred embodiment it is arranged inside the at least one nozzle.

The device is designed such that the fluid medium can be temperature-controlled preferably within a temperature range of −10° C. to 70° C.

The device according to the invention can be produced using the materials generally known in the field of technology, for example plastics, metals, metal alloys, ceramics, glass, wood and/or ivory.

In a preferred embodiment, that part of the device facing towards the region of the body is heat conductive and its temperature can be controlled. It can preferably be cooled by means known to the skilled person. Reference is here made to these means, which are preferably integrated in the device.

The device according to the invention can preferably be disinfected using customary disinfectants and is resistant to these, and it can also be sterilized by autoclaving.

In another further aspect, the invention relates to a cosmetic method for smoothing out cellulite, wherein regional, especially sub-regional, transdermal pressure is exerted on an area of skin to be treated with 1 to 50 kg per cm² of skin and, if appropriate, this process is repeated at least once. The pressure is preferably 10 to 30 kg per cm² of skin, particularly preferably 2 to 9 kg per cm² of skin.

Depending on the nature and extent of the cellulite, the method according to the invention can, if appropriate, be repeated at least once or can be repeated many times. Surprisingly, an improvement or reduction in the extent of the cellulite can be observed after carrying out the method according to the invention just once. For optimum smoothing-out of the cellulite, the cosmetic method according to the invention is carried out as a combination of different treatment sequences. In each individual treatment, the duration of treatment, the extent of the regional and in particular subregional transdermal pressure and/or the surface area to which the pressure is applied are adapted in such a way that optimum smoothing-out of the cellulite is achieved. The surface area for the subregional pressure is preferably up to 10 cm².

The cosmetic method according to the invention is preferably carried out in treatment blocks which are separated by regeneration intervals. The duration of treatment and the level of the regional and in particular subregional transdermal pressure used in each treatment block are particularly preferably increased in relation to the preceding treatment block, although they may, if appropriate, also be reduced in stages.

The method according to the invention has the advantage that it is noninvasive and thus easier to use, without requiring great outlay in terms of equipment and personnel.

With the method according to the invention, it was surprisingly possible to achieve results in terms of the smoothing-out of cellulite which were comparable to those of liposuction methods. However, these methods are expensive, time-consuming and associated with considerable pain for the person being treated. By contrast, the cosmetic method according to the invention is simple and inexpensive.

The application of regional or subregional transdermal pressure to an area of skin had not been expected to change subcutaneous tissue sufficiently to achieve uniform smoothing-out of cellulite. At the same time, it was surprising to find that it was possible, with the method according to the invention, to effect a two-dimensional, randomized and limited change of subcutaneous tissue, thus avoiding the formation of oil cysts and the associated negative concomitant phenomena, such as visible swelling.

In the method according to the invention, any fluid medium can be used for exerting the pressure, air or water preferably being used as the fluid medium. When using air or compressed air, an advantage has been found to be the cooling of the air which takes place upon decompression, which results in cooling of the area of skin being treated and thus results in less pain sensitivity of said area of skin. In this way, it is possible to further increase the applied pressure without the person treated sensing pain. As fluid medium, it is particularly preferable to use elastic and/or nonelastic particles, which preferably have spheroidal shapes. The fluid medium can additionally contain medical substances such as oils, lipids or liposomes.

In a preferred embodiment, the pressure is exerted without contact with a fixed surface. This has the advantage that no additional lubricants are needed, which makes the method according to the invention easy to implement.

In a preferred embodiment, a defined pressure is applied transdermally to the subcutaneous tissue, in order to rupture the latter, using a shaped article which is pressed onto it. A shaped article with a diameter of between 1 and 15 cm is preferably used, particularly preferably with a diameter of between 2 and 5 cm. For example, a stainless steel tube of 1 cm in diameter and 30 cm in length can be applied to the surface of the skin to be treated. The pressure application according to the invention is effected by moving the tube horizontally across the surface of the skin.

The shaped article used in the method according to the invention can additionally be provided with a measurement means for controlling the applied pressure, e.g. via a piezo effect or via a mechanical spring.

The shaped article is used by moving it across the region of the body to be treated, exerting pressure values of 1 to 50 kg per square centimeter, preferably 10 to 30 kg per square centimeter, particularly preferably 2 to 9 kg per square centimeter, depending on the individual condition of the skin and subcutaneous tissue.

In the method according to the invention, it is possible to use shaped articles with differently configured surfaces. Said surface can be smooth or rough and preferably has knob-like raised areas and/or pit-like depressions. A roller is particularly preferably used as the shaped article.

In a preferred embodiment, the method according to the invention is characterized by the fact that the pressure is exerted mechanically by means of a plurality of parallel-running wheels of conical cross section.

In a further aspect of the method according to the invention, the pressure is exerted via a shaped part made of suitable materials, such as metal or plastic. A shaped part used according to the invention comprises a handle and a surface directed toward the skin with a plastically configured relief, preferably of sinusoidal form. The skin is preferably pretreated with an agent increasing lubrication, in particular with a massage oil. The shaped part can then be moved by hand more easily across the region of the body to be treated, and with suitable contact pressure. Upon application to the skin, pressure peaks arise in the area of the maximum protrusions of the shaped part, as a result of which subcutaneous tissues, preferably subcutaneous fatty cells, are in the first instance two-dimensionally changed at random and to a limited extent, and, secondarily, there is a smoothing-out of the treated skin surfaces. To achieve uniform smoothing-out of the skin, the process is preferably repeated several times.

In a preferred embodiment, the pressure on the skin and subcutaneous tissue is produced intermittently in order, by the action of the acceleration then obtained, to reduce the pressure which would otherwise be necessary. The method according to the invention is preferably carried out with frequencies of between 5 Hz and 20 kHz, particularly preferably of between 15 Hz and 1 kHz.

The vibrations can be produced, for example, by eccentric cams, compressed air, electric or magnetic fields. The important features are the relatively great mass of the drive mechanism compared to the relatively low mass of the vibrating body, and the high speed with which the vibrating body impacts the skin. In contrast to the method of ultrasound-assisted destruction of fatty cells, the present method involves transmitting a mechanical vibration through the skin with relatively low frequencies and increased pressure. For this reason, the vibrating body should have as great a mass as possible, although this should be significantly less than the mass of the motor, so as to keep vibrations of the latter to a minimum. The direction of stimulation can be vertical or horizontal relative to the skin surface, and it is preferable to use a combination of different directions of stimulation. A distinctive feature compared to vibrators, massage rods and rotating brushes is that only an increased pressure applied according to the invention leads to destruction of subcutaneous tissue.

The mechanical pressure is preferably exerted by means of a vibrating body at a frequency of between 5 Hz and 20 kHz.

In a preferred embodiment of the invention, the frequency of the vibrating body is controlled in such a way that resonance effects occur with the restoring forces of the tissue. The latter differ between individuals.

A further improvement of the method according to the invention is achieved by the fact that the region of the body to be treated is incorporated in elastic or nonelastic material or is covered by this. For example, the outside of a thigh can be fixed by wrapping it in either elastic or nonelastic dressings. These dressings are preferably foils, which are optionally transparent. On the side facing toward the skin, or on the opposite side, the foils can have surface structures such as knobs.

To carry out the method according to the invention, the part of the body to be treated can be placed, if appropriate, in a semicircular shell or in splints. Corresponding technical devices for individually adaptable semicircular splints are known to the skilled person, and reference is hereby made to these.

In the method according to the invention, a piezo foil is preferably used which, for example, is wound in a circle around an extremity and fixed tight. By applying an alternating voltage, a rhythmic compression of the skin surface to be treated is preferably obtained, which leads finally to smoothing-out of the skin. The mechanical prestressing is in this case set with the foil as required. The alternating voltage applied is set individually to the desired frequencies in the range of 5 Hz to 20 kHz. It is preferably set to 15 Hz to 1 kHz. The pressure amplitude can be regulated by the electrical voltage or the mechanical prestressing. To carry out the method according to the invention, it is possible to use any system for intermittent pressure transmission with which an alternating pressure effect can be obtained. A system with circularly arranged pressure chambers and air pressure, water pressure or oil pressure is preferably used.

In a further aspect of the invention, a preferred embodiment is used in particular regions, for example on the neck, which embodiment makes use of the inclination of the skin and of the subcutaneous tissue in certain regions of the body in order to develop coarse folds or doubling. Such a tissue doubling can be gripped “bilaterally” from both sides using a vise-like or forceps-like device and, by defined pressure application, it is possible to liquefy the subdermal fatty tissue while preserving the skin. A forceps-like device can in turn have rollers on its arms. The jaws or arms on one side or both sides can be moved in opposite directions for vibration.

In a preferred embodiment, the method according to the invention is carried out in a fluid medium, preferably in a temperature-controlled water bath.

In a further preferred embodiment, the method according to the invention is combined with liposuction method. A great reduction in volume is achieved by the liposuction, and further uniform smoothing-out of the cellulite is achieved by the method according to the invention.

Finally, the invention relates to the use of a device according to the invention for treating cellulite.

The success of treatment with the method according to the invention can be easily monitored visually or by palpating the treated areas of the body.

The method according to the invention can, if appropriate, be combined with known methods for treating pain. This is advantageous because the pain sensitivity of the person being treated is triggered as the pressure applied according to the invention increases. Such methods for treating pain include local cooling of the tissue, application of so-called local anesthetics, nerve conduction blockade and regional anesthesia, or even general anesthesia. Local cooling and an associated reduction in pain sensitivity of the area of skin to be treated is achieved, for example, by using air, in particular compressed air, in the method according to the invention. The air is decompressed on impacting the skin, which results in cooling of the air and thus cooling of the skin surface.

1. A device for transdermally exerting a defined pressure on subcutaneous tissue, especially where cellulite is present, wherein said device is intended to produce a jet pressure in the range of 1 to 20 bar, so that no mechanical contact is necessary between the device and the skin, and said device has at least one nozzle for a fluid medium.

2. The device as claimed in claim 1, wherein the jet width and/or the jet pressure can be regulated.

3. The device as claimed in claim 1 or 2, wherein said device is intended for a fluid medium preferably comprising air or water.

4. The device as claimed in one of the preceding claims, wherein said device is intended to produce a pulsating jet pressure.

5. The device as claimed in one of the preceding claims, wherein said device has means for controlling the temperature of the fluid medium.

6. A cosmetic method for smoothing out cellulite, wherein regional, especially sub-regional, transdermal pressure is exerted on an area of skin to be treated with 1 to 50 kg per cm² of skin and, if appropriate, this process is repeated at least once.

7. The method as claimed in claim 6, wherein the pressure is exerted by means of a fluid medium.

8. The method as claimed in claim 7, wherein air or water is used as the fluid medium.

9. The method as claimed in one of claims 6 through 8, wherein the pressure is exerted without contact with a fixed surface.

10. The method as claimed in claim 6, wherein the pressure is exerted mechanically by means of a shaped article being pressed on.

11. The method as claimed in claim 10, wherein a shaped article with a diameter of between 1 and 15 cm, preferably between 2 and 5 cm, is used.

12. The method as claimed in claim 10 or 11, wherein the shaped article used has a means for controlling the applied pressure.

13. The method as claimed in one of claims 10 through 12, wherein the surface of the shaped article has knob-like raised areas and/or pit-shaped depressions.

14. The method as claimed in one of claims 10 through 13, wherein a roller is used as the shaped article.

15. The method as claimed in claim 10, wherein the pressure is exerted mechanically by a plurality of parallel-running wheels of conical cross section.

16. The method as claimed in one of claims 10 through 15, wherein the skin is pre-treated with an agent which increases lubrication, in particular with a massage oil.

17. The method as claimed in claim 6, wherein the mechanical pressure is exerted by an vibrating body which has a frequency of between 5 Hz and 20 kHz.

18. The method as claimed in claim 17, wherein the frequency of the vibrating body is regulated in such a way that resonance effects occur with the restoring forces of the tissue.

19. The method as claimed in claim 6, wherein the region of the body to be treated is incorporated in elastic or nonelastic material or is covered with this.

20. The method as claimed in claim 19, wherein the material is a piezo foil.

21. The method as claimed in claim 20, wherein a rhythmic compression of the area of skin to be treated is produced by applying an alternating voltage.

22. Use of a device as claimed in one of claims 1 through 5 for treating cellulite.
